(19) United States
(12) Patent Application Publication
(10) Pub. No.: US 2026/0189741 A1
(43) Pub. Date: Jul. 2, 2026

(54) INFLIGHT ENTERTAINMENT SYSTEM CONTROLLING SERVICES BASED ON SEATBELT STATUS MONITORING

(71) Applicant: Thales Avionics, Inc., Irvine, CA (US)

(72) Inventors: Kevin JUDD, Irvine, CA (US); Martin PARRENS, Satellite Beach, FL (US); Antonio FEMIANO, Lake Forest, CA (US); Margaret STUART, Mission Viejo, CA (US)

(21) Appl. No.: 19/005,037

(22) Filed: Dec. 30, 2024

(51) Int. Cl. H04N 21/25; B64D 11/00; B64D 45/00; H04N 21/214; H04N 21/4223; H04N 21/442; H04N 21/488

(52) U.S. Cl. CPC H04N 21/25; B64D 11/00151; B64D 11/00152; B64D 45/00; H04N 21/2146; H04N 21/4223; H04N 21/44218; H04N 21/4882; B64D 2045/007

(57) ABSTRACT

Various embodiments are directed to an inflight entertainment system including a content server storing content for distribution through at least one cabin network to video display units. The content server is operative to perform various operations including obtaining through cabin network seatbelt status indications indicating whether seatbelt mechanisms associated with passenger seats are fastened. The operations include determining that fastened seatbelts are required for passengers. The operations include identifying based on the seatbelt status indications which of the seats are occupied by passengers and do not have seatbelt mechanisms fastened. The operations include identifying a video display unit that is associated with the identified seat. The operations include communicating through at least one cabin network to the video display unit a notification indicating that fastening of the seatbelt mechanism is required. The operations include triggering performance of a remedial action operation through the content server.

### FIELD OF THE INVENTION

The present disclosure relates to inflight entertainment systems for use in aircraft.

### BACKGROUND

Flight crew are tasked with monitoring passenger activity while onboard aircraft and during all flight phases, including taxiing for takeoff, takeoff roll, climbing to altitude, during safety situations such as turbulence, landing approach, and taxing to an airport gate. Flight safety regulations require that flight crew ensure that passengers remain seated with fastened seatbelts, seats remain in an upright position, and tray tables remain stored in a locked position during some of the flight phases such as taxiing, takeoff, and landing and during certain flight safety situations.

Crew members typically broadcast instructions through speakers and sometimes through seat video display units to passengers, and subsequently travel along the aisles to visually observe passengers'compliance and to provide passenger targeted follow-up instructions when needed.

However, it is known that some passengers ignore or don't understand the initial broadcasted crew instructions and fail to follow-through on targeted follow-up instructions. It is also known that passengers are capable of quickly unfastening seatbelts, deploying tray tables, reclining seats, etc., when the crew members are no longer observing. Besides being an inefficient use of crew member resources, serious passenger and flight safety concerns are created when passenger compliance with crew member instructions is not ensured at all times.

### SUMMARY

Various embodiments of the present disclosure are directed to an inflight entertainment system. The inflight entertainment system includes a content server storing content for distribution through at least one cabin network to video display units. The content server is operative to perform various operations. The operations include obtaining through the at least one cabin network seatbelt status indications indicating whether seatbelt mechanisms associated with passenger seats are fastened. The operations determine that fastened seatbelts are required for passengers. The operations also include, responsive to the determination, identifying based on the seatbelt status indications which of the seats are occupied by passengers and do not have seatbelt mechanisms fastened. The operations also include, for each of the identified seats, identifying 406 a video display unit that is associated with the identified seat. The operations also include, for each of the identified seats, communicating through the at least one cabin network to the video display unit a notification indicating that fastening of the seatbelt mechanism is required. The operations also include, for each of the identified seats and responsive to expiration of a defined threshold time since communication of the notification without having received a seatbelt status indication associated with the identified seat indicating that the seatbelt mechanism is fastened, trigger performance of a remedial action operation through the content server.

Various embodiments are directed to a method performed by an inflight entertainment system comprising a content server storing content for distribution through at least one cabin network to video display units. The method includes obtaining through the at least one cabin network seatbelt status indications indicating whether seatbelt mechanisms associated with passenger seats are fastened. The method also includes determining that fastened seatbelts are required for passengers and responsively identifying based on the seatbelt status indications which of the seats are occupied by passengers and do not have seatbelt mechanisms fastened. The method also includes, for each of the identified seats, identifying a video display unit that is associated with the identified seat. For each of the identified seats, the method communicates through the at least one cabin network to the video display unit a notification indicating that fastening of the seatbelt mechanism is required. The method also includes, for each of the identified seats and responsive to expiration of a defined threshold time since communication of the notification without having received a seatbelt status indication associated with the identified seat indicating that the seatbelt mechanism is fastened, triggering performance of a remedial action operation through the content server.

These and further embodiments are described in detail below with regard to the following drawings. Corresponding inflight entertainment systems, methods and computer program products are also disclosed. It is intended that all such inflight entertainment systems, methods and computer program products be included within this description, be within the scope of the present inventive subject matter, and be protected by the accompanying claims. Moreover, it is intended that all embodiments disclosed herein can be implemented separately or combined in any way and/or combination.

### BRIEF DESCRIPTION OF THE DRAWINGS

Other features of embodiments will be more readily understood from the following detailed description of specific embodiments thereof when read in conjunction with the accompanying drawings, in which:

FIG. 1 illustrates cameras positioned over seats to provide video streams to an IFE server that identifies the state of seatbelt mechanism and can be used by the IFE system to trigger notifications when one or more rules are satisfied, in accordance with some embodiments of the present disclosure;

FIG. 2 is a block diagram of an inflight entertainment system with cameras that are spaced apart along an aircraft cabin to observe seating areas and which supply video streams to an IFE server to recognize if seatbelt mechanism are fastened, provide notifications to crew terminals and/or to passenger seat video display units, and perform remedial actions, in accordance with some embodiments of the present disclosure;

FIG. 3 is a block diagram of an IFE server having elements that are configured in accordance with some embodiments of the present disclosure; and

FIG. 4 is a flowchart of operations that may be performed by the inflight entertainment system, in accordance with some embodiments of the present disclosure.

### DETAILED DESCRIPTION

In the following detailed description, numerous specific details are set forth in order to provide a thorough understanding of embodiments of the present disclosure. However, it will be understood by those skilled in the art that the present invention may be practiced without these specific details. In other instances, well-known methods, procedures, components and circuits have not been described in detail so as not to obscure the present invention. It is intended that all embodiments disclosed herein can be implemented separately or combined in any way and/or combination.

Various embodiments of the present disclosure are directed to providing improved monitoring passenger activity with vehicle seat mechanisms, including whether seat belt buckles are fastened or unfastened. Some further embodiments can generate automatic notifications to crew terminal(s) (e.g., Interactive Cabin Management Terminal (iCMT)) or to video display units associated with particular passengers when one or more defined notification rules are satisfied responsive to the monitored activities. Some further embodiments can perform actions based on a response or lack of response to the automatic notifications.

Fasten seatbelt notifications on aircraft are safety alerts designed to inform passengers when they should secure their seatbelts. These notifications are typically indicated by an illuminated seatbelt sign above each seat and are often accompanied by an audible chime and an announcement from the flight crew. The seatbelt sign is turned on during critical phases of the flight, such as takeoff, landing, and when the aircraft encounters turbulence. The primary purpose of these notifications is to ensure passenger safety by minimizing the risk of injury during unexpected movements of the aircraft. Adhering to these notifications helps maintain a safe environment for everyone on board.

Ignoring traditional fasten seatbelt notifications on aircraft can lead to significant safety risks. Turbulence, which is often unpredictable, can cause sudden and severe jolts. Passengers who are not buckled up can be thrown from their seats, leading to injuries ranging from minor bruises to serious trauma. In extreme cases, unrestrained passengers can become projectiles, endangering themselves and others. The Federal Aviation Administration (FAA) reports that turbulence is the leading cause of injuries to passengers and flight attendants in non-fatal accidents. Therefore, adhering to seatbelt notifications is crucial for minimizing these risks.

Beyond the immediate physical dangers, ignoring seatbelt notifications can also disrupt the overall safety protocols of the flight. Flight attendants are responsible for ensuring that all passengers comply with safety regulations, and non-compliance can divert their attention from other critical duties. This can delay the cabin crew's ability to respond to other emergencies or perform essential tasks, such as securing the cabin for landing. Additionally, non-compliance can create a domino effect, where other passengers might also ignore safety instructions, further compromising the safety of the flight.

Moreover, ignoring seatbelt notifications can have legal and financial repercussions. Airlines have strict policies regarding passenger safety, and failure to comply with these regulations can result in fines or other penalties. In some jurisdictions, passengers who refuse to follow safety instructions can be removed from the flight or banned from future travel with the airline. Furthermore, in the event of an injury caused by passenger non-compliance, airlines may face difficulties with insurance claims or legal liabilities. Therefore, it is in the best interest of passengers to adhere to seatbelt notifications to avoid these potential consequences. Likewise, improper enforcement or a failure to enforce or properly notify passengers of the fasten seatbelt notifications and the possible danger of expected turbulence may expose the airline and crew members to liability for passenger injuries and/or Federal Aviation Administration (FAA) fines.

However, despite the adverse risks, passengers routinely disregard or fail to notice seatbelt notifications. With passengers'access to entertainment on flights through inflight entertainment (IFE) systems, capturing passengers'attention or reminding the passengers of a seatbelt notification may be more difficult than ever.

Policing adherence to fasten seatbelt notifications on aircraft presents several challenges. Flight crew traditionally must constantly monitor the cabin to ensure compliance, which can be difficult during busy periods or when attending to other duties. Passengers may ignore or forget the notifications, especially during long flights when they feel the need to move around. Additionally, cultural differences and language barriers can lead to misunderstandings about the importance of these notifications. Enforcing compliance can also be sensitive, as it requires balancing firmness with customer service. These factors make it challenging for flight crew to ensure that all passengers remain safely buckled when required.

While various embodiments of the present disclosure are discussed and illustrated in an aircraft cabin environment, these embodiments may be applied in many different vehicles such as but not limited to cars, trains, cruise ships, water vehicles, and buses. When used in an aircraft, a bus, a train, or other vehicle where seats are arranged in rows and columns, the video display units can be attached to seatbacks so they face passengers/users in adjacent rearward seats. The video display units may alternatively be mounted to bulkheads, movable support assemblies connected to seat armrests and/or seat frames, etc. The video display units may include devices that are transported by or provided to passengers/users, such as mobile phones, tablet computers, laptop computers, etc.

### Example Inflight Entertainment Systems for Seatbelt Recognition and Monitoring

Inflight entertainment systems and cameras may be used to assist flight crews to ensure fastening seatbelt notification are followed by passengers.

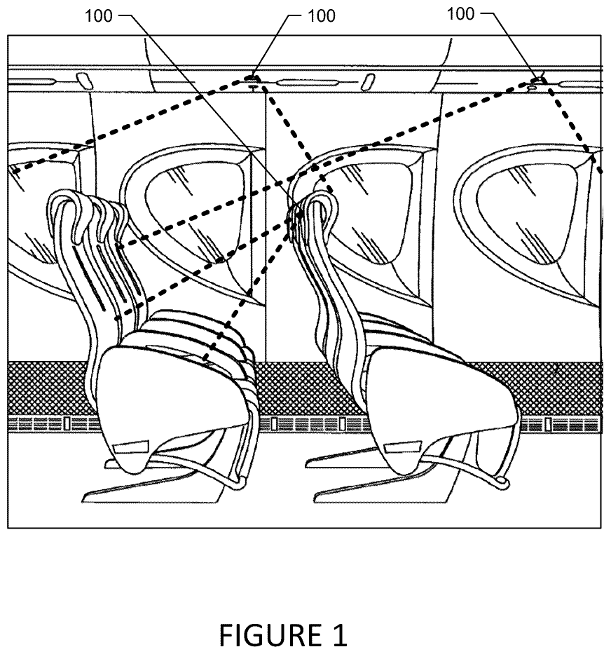

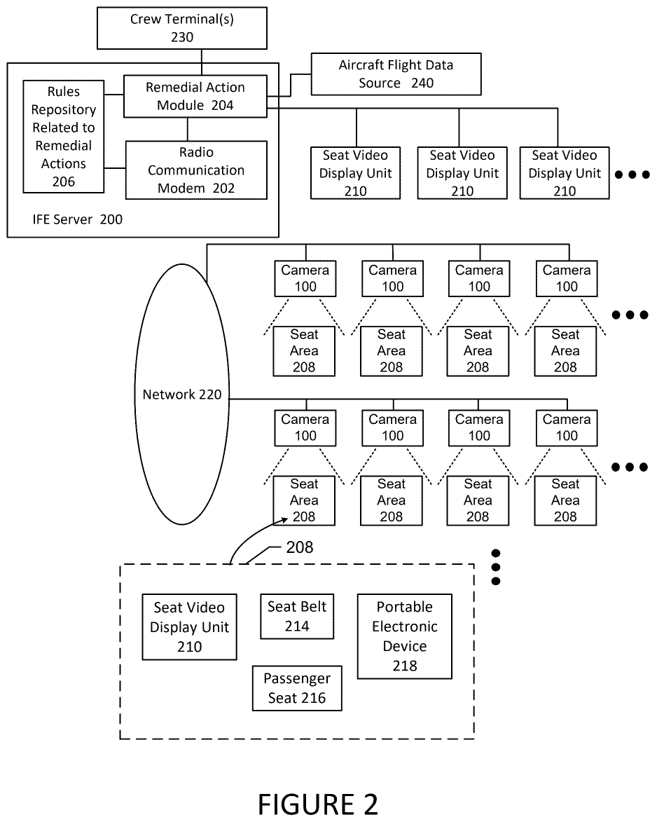

FIG. 1 illustrates cameras 100 that are positioned to have a view of a passenger seat and provide video streams to an inflight entertainment server (200 in FIG. 2) that identifies status of seatbelt mechanisms and can trigger notifications when one or more rules are satisfied. The cameras 100 may be positioned in many locations and configurations. Referring to FIG. 1, cameras 100 may be position over seats to have a broader field of view of multiple passenger seats. Also referring to FIG. 1, the cameras 100 may also or alternatively be located on another passenger seat or vehicle feature (e.g., wall) located directly in front of the passenger seat to have a narrower and more direct view of a specific feature (e.g., a seat belt) of the passenger seat. Cameras 100 located on another passenger seat or vehicle feature may be physically located as part of an inflight entertainment system, such as a seat video display unit (SVDU), located on the another passenger seat or vehicle feature. The cameras 100 not physically located as part of inflight entertainment system may be communicatively coupled to an inflight entertainment system.

Each of the cameras 100 is optically configured and mounted to have a field-of-view (FOV), illustrated as an angle between dashed lines, that captures in its output video stream at least part of at least one seat area. For example, each camera 100 may be optically configured and mounted over each passenger seat adjacent to ceiling-mounted reading lights, so that three cameras 100 are spaced apart each adjacent to a different one of three reading lights positioned over three adjacent seats in a row. Alternatively, each camera 100 may be optically configured and mounted to capture in its output video stream at least a part of each seat area in a row so that only a single camera 100 is positioned over each row of seats. Alternative, each camera 100 may be optically configured and mounted to capture in its output video stream at least a part of at least one seat area in two or more rows of seats so that fewer cameras are needed to monitor passenger activity in those seating areas of an aircraft cabin, and which may correspondingly reduce the number of resulting video streams from the cameras 100 that need to be processed by the inflight entertainment server. The cameras 100 are each electrically configured to provide their output video streams through one or more cabin networks within the aircraft to the inflight entertainment server, which may be part of an in-flight entertainment system or separate therefrom and which may reside in a line replaceable unit (LRU) or other electronics enclosure.

Object recognition is performed on the output video streams of the cameras 100 to determine the presence of a passenger in a seat and if the seatbelt mechanism of the passenger is properly buckled.

Various embodiment of the present disclosure are directed to an inflight entertainment system. The inflight entertainment system includes a content server storing content for distribution through at least one cabin network to video display units. The content server is operative to perform various operations.

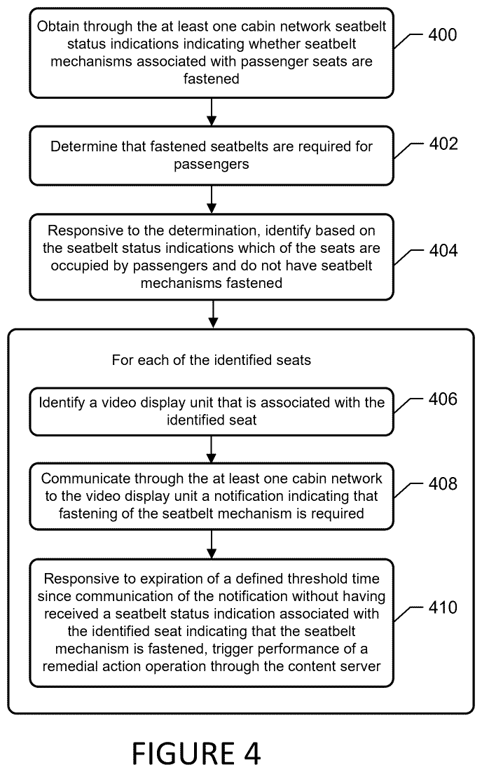

FIG. 4 is a flowchart of operations that may be performed by the inflight entertainment system, in accordance with some embodiments of the present disclosure.

Referring to the various embodiments of the present disclosure, the operations include obtaining 400 through the at least one cabin network seatbelt status indications indicating whether seatbelt mechanisms associated with passenger seats are fastened. The operations determine 402 that fastened seatbelts are required for passengers. The operations also include, responsive to the determination, identifying 404 based on the seatbelt status indications which of the seats are occupied by passengers and do not have seatbelt mechanisms fastened. For each of the identified seats, the operations identify 406 a video display unit that is associated with the identified seat. For each of the identified seats, the operations communicate 408 through the at least one cabin network to the video display unit a notification indicating that fastening of the seatbelt mechanism is required. The operations also include, for each of the identified seats and responsive to expiration of a defined threshold time since communication of the notification without having received a seatbelt status indication associated with the identified seat indicating that the seatbelt mechanism is fastened, trigger 410 performance of a remedial action operation through the content server.

The content server may be configured to support delivery of content stored in on-board memory and/or delivery of content obtained off-board through satellite networks. Off-board content can be provided from ground-content servers operated by an airline, IFE service provider, etc., and from Internet over-the-top servers such as television and movie streaming servers.

The video display units may be video display units (VDUs), such as seatback VDUs built into another passenger seat or vehicle feature (e.g., wall) located in front of the seat of the passenger being monitored. The video display units may be portable electronic devices, such as smartphones, tablet, or laptops.

The least one cabin network may be a wired network, such as Ethernet network, and/or wireless, such as a WiFi, cellular, or satellite network.

In some embodiments, the operation to determine 402 that fastened seatbelts are required for passengers includes performing at least one of: 1) processing video from cameras positioned to view passenger seats to identify seatbelt fastening status; 2) signaling received from seatbelt fasten sensors operative to indicate whether a seatbelt mechanism is fastened; and 3) query the passenger to acknowledge that the seatbelt mechanism is fastened.

In some embodiments, the operation to determine 402 that fastened seatbelts are required for passengers includes at least one of: 1) receiving a command from a crew terminal through the at least one cabin network, 2) obtaining an expected turbulence status indication indicating a level of expected turbulence or level of measured turbulence exceeding a threshold, 3) obtaining a flight phase status indicating the aircraft is entering or within a defined flight phase. The level of measured turbulence may have been measured by the aircraft the inflight entertainment system is located on or from another aircraft. The flight phase status may indicate that the aircraft being presently being operated to perform an action, such as taxiing, a takeoff, a departure climb, an arrival descent, preparing for landing, or landing.

In some embodiments, the notification indicating that fastening of the seatbelt mechanism is required is communicated 408 through at least one of: a video message to be displayed on the video display unit, a text notification to be displayed on the video display unit, a photographic icon to be displayed on the video display unit, and an audio announcement to be played through an audio port of the video display unit.

### Example Inflight Entertainment System Operations for Correcting Noncompliant Passenger Actions

The inflight entertainment system may perform many kinds of remedial action operations to encourage a passenger to comply with a fasten seatbelt notification. In some embodiments, the remedial actions escalate in inconvenience the longer the fastened seatbelt requirement is ignored.

For example, when a passenger is detected not wearing their seatbelt during a notification, the inflight entertainment system can automatically pause their current entertainment and display a prominent alert on their screen, reminding them to fasten their seatbelt, and confirm through the pop up message that they have fastened their seat belt. For example, a message can be displayed on a passenger's SVDU and/or PED informing the passenger their seatbelt must be fastened, and include a passenger selectable acknowledgment that asks the passenger to verify or confirm that they have fastened their seatbelt. If the system doesn't then receive the passenger's acknowledgment of compliance within a threshold time, the system can trigger various actions as described herein. For example, the crew terminal (iCMT) could be notified that passenger in seat XA hasn't confirmed seatbelt fastened, IFE content server could pause steaming or content to the passenger's SVDU and/or PED until the passenger's acknowledgment of compliance is received, and/or the IFE content server could cause the SVDU to turn off or otherwise disable all IFE services for that passenger. This approach not only reinforces the importance of the safety measure but also leverages the inflight entertainment system's engagement to capture the passenger's attention effectively. The inflight entertainment system is also uniquely capable of communicating with many passengers who are not complying with the fasten seatbelt notification because of diverse traits of passengers, such as cultural differences, language barriers, and/or disabilities. By integrating these features into the inflight entertainment system, airlines can enhance onboard safety and ensure that passengers adhere to critical safety protocols.

Notifications and responsive actions can be implemented in three example scenarios involving the inflight entertainment server. First, the inflight entertainment server controls the delivery of onboard stored content directly to seat video display units. Second, the server manages the streaming of onboard stored movies and other content to Personal Electronic Devices (PEDs) through the aircraft's WiFi network. Third, the server utilizes satellite communication modems to provide Internet connectivity to PEDs. In this scenario, the server detects if a seatbelt is not fastened at a particular seat and triggers a notification to the associated PED. If necessary, the server also throttles or terminates the Internet connectivity for that PED.

For example, during movie playback on a seat video display unit, the inflight entertainment server may escalate notifications as follows: the first notification is provided as a scrolling closed caption-style text overlay on the movie. The second notification is displayed as a centered text overlay, obscuring the movie. The third notification pauses the movie playback and displays the notification until the seatbelt is fastened. The fourth notification terminates the movie playback, displays a warning text, and/or subsequently turns off the seat video display units.

In another example, during PED streaming from content on the inflight entertainment server, two approaches for escalation may be implemented. The first approach involves the inflight entertainment server inserting warnings as described above. The second approach involves the airline app running on the PED, which responds to commands from the inflight entertainment server monitoring seatbelt connections. This detailed approach ensures continuous reminders for passengers to fasten their seatbelts, enhancing overall safety during the flight.

These embodiments are summarized below.

In some embodiments, the remedial action operation performed by the content server includes sending further messaging to the passenger, including a notification to the passenger that a remedial action will occur if the seatbelt mechanism is not fastened, and, e.g., confirmed by the passenger through a pop up notification message.

In some embodiments, the remedial action operation performed by the content server includes turning the inflight entertainment system off.

In some embodiments, the remedial action operation performed by the content server comprises pausing a media content being displayed on the video display unit until the seatbelt mechanisms are determined to be fastened.

In some embodiments, the remedial action operation performed by the content server comprises throttling allowed communication bandwidth for Internet access through the at least one cabin network until the seatbelt mechanisms are determined to be fastened. For example, the system may throttle bandwidth allowed for a passenger to stream content from ground based Internet sites to the passenger's PED and/or to the passenger's seat display. As explained above, a seatbelt fastening notification may be displayed on seat displays and when a particular passenger has not confirmed that their seatbelt is fastened within a threshold time, the system can initiate a remedial action, such as throttling bandwidth, for that particular passenger. Example approaches are now described for how the system can determine which passengers and/or PEDs are associated with which seats and, thereby, which seat displays so that remedial action, e.g., throttling bandwidth, can property target a passenger who has, for example, failed to timely confirm that their seatbelt is fastened.

In an illustrative example scenario, a passenger prepays for WiFi and receives a token. During the flight, when the passenger redeems the token, the inflight entertainment system can ask for their seat number. Alternatively, the seat number can be requested at the time of prepayment. If the token is redeemed during the flight, the system can prompt the passenger to verify their seat number. Another option is to ask for the passenger's name, couple the token with the name, and then look up the seat number using the passenger seat assignment manifest. This manifest is held by the airline and is accessible under certain conditions, though accessing it may raise privacy concerns. When paying by credit card, the passenger enters the passenger's name, which can be used to embed the seat number in the WiFi token. Upon redeeming the token onboard, the inflight entertainment system can extract the seat number from the token and ask the passenger to confirm it. If the provided seat number does not match the one indicated by the WiFi token, the system can further query the passenger.

In a second illustrative example scenario, a passenger pays for WiFi onboard the aircraft. The inflight entertainment system then asks the passenger for the passenger's seat number. When the token is redeemed during the flight, the inflight entertainment system can prompt the passenger to verify the passenger's seat number. Alternatively, the inflight entertainment system can ask for the passenger's name, couple the token with the name, and look up the seat number using a passenger seat assignment manifest.

In some embodiments, the remedial action operation performed by the content server comprises, sending notification to the crew terminal indicating a location of passenger accommodations (LOPA) map as to the seatbelt status of the passenger. In some other embodiments, the system reduces, suspends, or terminates bandwidth allowed to be used by a seat display of a passenger and/or a PED operated by the passenger who has failed to timely confirm that their seatbelt is fastened.

As mentioned above, the crew terminal(s) may be an Interactive Cabin Management Terminal (iCMT).

A record of noncompliance and the remedial actions performed may be kept to be reviewed by an airline employee later. The record may be particularly valuable when determining which remedial actions have the highest success rate or in the case of injury or legal/insurance claims. Accordingly, in some embodiments, the remedial action operation performed by the content server comprises recording the seatbelt status from the crew terminal as a log with the heartbeat of the screen for further examination by an airline employee.

The LOPA map could also be displayed on a crew member's PED, to know the status of a seatbelt of a sleeping passenger, regardless of whether the seatbelt is visible.

If the IFE system has a camera in the display, it could be used to determine whether a passenger is seated in the seat, as well as a possibility of determining the seat belt status (depending on where the camera is located on the display).

If the IFE system is aware of the status of the fasten seatbelt sign, it can provide notifications to passengers through the IFE display, instructing them to fasten their seatbelts. This system could require an indication mechanism, such as a smart seatbelt or a camera integrated into the display, to verify whether the passenger has complied with the request. If the passenger has not fastened their seatbelt, the system would prompt them to confirm through the touch display that their seatbelt is secured. Alternatively the system could query the passenger through an IFE display or PED to request confirmation that the passenger's seatbelt is fastened. As explained above, when the system queries the passenger and does not receive confirmation of fastened seatbelt within a threshold time, the system can trigger remedial actions.

The IFE system would continuously monitor the status of the seatbelt while the fasten seatbelt sign is illuminated. If the passenger unfastens their seatbelt while the sign is still on, the system will send additional reminders to re-fasten the seatbelt. Should the passenger fail to comply within a programmable time limit, the system would escalate the reminders and issue a warning that the inflight entertainment system will be deactivated. Additionally, a LOPA map would be provided to the iCMT, indicating the seatbelt status throughout the cabin. The inflight entertainment system would log the seatbelt status from the iCMT, along with the screen's heartbeat, for further examination, particularly in cases of injury or legal/insurance claims.

Furthermore, the LOPA map could be displayed on a crew member's PED, allowing them to check the seatbelt status of a sleeping passenger, even if the seatbelt is not visible. If the inflight entertainment system includes a camera in the display, it could be utilized to determine whether a passenger is seated and potentially ascertain the status of the seatbelt, depending on the camera's placement on the display. This comprehensive approach ensures that passenger safety is maintained and that compliance with seatbelt regulations is effectively monitored and enforced.

Operations may be repeated to continually monitor the status of seatbelt mechanism and trigger remedial actions as needed.

In some embodiments, The inflight entertainment system monitors whether the passenger keeps the seatbelt fastened while the fasten seatbelt sign is on, or removes the seatbelt, and repeats the operations performed by the content server above to continually monitor and trigger remedial action as-needed or after a threshold amount of time. In other words, in some of these embodiments, the content server is further operative to, responsive to a threshold amount of time elapsing, repeating the following operations until the seatbelt mechanisms associated with passenger seats are fastened. The operations include obtaining through the at least one cabin network seatbelt status indications indicating whether seatbelt mechanisms associated with passenger seats are fastened. The operations determine that fastened seatbelts are required for passengers. Responsive to the determination, the operations identify based on the seatbelt status indications which of the seats are occupied by passengers and do not have seatbelt mechanisms fastened. For each of the identified seats, the operations identify a video display unit that is associated with the identified seat. The operations also include, for each of the identified seats, communicating through the at least one cabin network to the video display unit a notification indicating that fastening of the seatbelt mechanism is required. The operations also include, for each of the identified seats and responsive to expiration of a defined threshold time since communication of the notification without having received a seatbelt status indication associated with the identified seat indicating that the seatbelt mechanism is fastened, trigger performance of a remedial action operation through the content server.

In some embodiments, the steps are repeated upon the change of the fastened seatbelt requirement from not required to required. In other words, in some embodiments, responsive to a determining fastened seatbelts changed from not required to required for passengers, repeating until the seatbelt mechanisms associated with passenger seats are fastened, performing the following operations. The operations include obtaining through the at least one cabin network seatbelt status indications indicating whether seatbelt mechanisms associated with passenger seats are fastened. The operations also include identifying based on the seatbelt status indications which of the seats are occupied by passengers and do not have seatbelt mechanisms fastened. The operations also include, for each of the identified seats, identifying a video display unit that is associated with the identified seat. The operations also include, for each of the identified seats, communicating through the at least one cabin network to the video display unit a notification indicating that fastening of the seatbelt mechanism is required. The operations also include, for each of the identified seats and responsive to expiration of a defined threshold time since communication of the notification without having received a seatbelt status indication associated with the identified seat indicating that the seatbelt mechanism is fastened, trigger performance of a remedial action operation through the content server.

For example, Responsive actions tied to notifications above, airline app running on PED can throttle allowed communication bandwidth for Internet access through aircraft satellite and/or cellular network connectivity, pause Internet access, or terminate Internet access.

### Example Inflight Entertainment System Configurations

As will be explained in further detail below, FIG. 2 is a block diagram of an inflight entertainment system with cameras that are spaced apart along an aircraft cabin to observe seating areas and which supply video streams to an IFE server to recognize if seatbelt mechanism are fastened, provide notifications to crew terminals and/or to passenger seat video display units, and perform remedial actions, in accordance with some embodiments of the present disclosure.

Referring to the example of FIG. 2, the example inflight entertainment system includes cameras 100, the IFE server 200, one or more crew terminals 230 (e.g., crew accessible computers mounted on aircraft structures and/or transportable by crew), and may include seat video display units 210. Each of the cameras 100 are configured to output video streams through one or more cabin networks 220 to the IFE server 200. The example cameras 100 are illustrated as having a one-to-one correspondence to each seat area 208, whereby each camera may be positioned, for example, overhead a seat adjacent to a seat-focused reading light, with a FOV configured so that the video stream that is output therefrom captures one or more seatbelt mechanisms 214 that can be present in the seat area 208 and which the IFE server 200 is configured to identify. However, as explained above with regard to FIG. 1, the cameras 100 may alternatively be each optically configured and mounted to output a video stream that captures objects located in more than one seat area 208.

Other ways of automatically sensing whether a seatbelt mechanism can be used. For example, seatbelt mechanisms may include a sensor that operates to provide an electrical signal to the IFE server 200, e.g., through a seat display or directly, indicating whether a seatbelt mechanism is fastened. Alternatively, an infrared (IR) sensor, radar device, RF imaging, or other imaging sensor may be positioned to view one or more passenger seatbelts and operate to provide signals to the FIE server 200 indicating which seatbelts are fastened or unfastened.

The IFE server 200 can utilize a radio communication modem 202 that operates to communicate through the network 220. The radio communication modem 202 may communicate through a wired network, such as Ethernet network, and/or wireless, such as a WiFi, cellular, or satellite network.

The IFE server 200 can determine when a passenger is detected not wearing their seatbelt during a notification. The IFE server 200 can further execute a remedial action module 204 that triggers one or more kinds of remedial action operations to encourage a passenger to comply with a fasten seatbelt notification.

In some further embodiments, the remedial action module 204 can select among the rules in the rules related to remedial actions 206 based on electronic commands that are received from crewmembers, e.g. via the crew terminal 230, and/or that are identified responsive to characteristics of aircraft flight data from the source 240, e.g., flight cabin network. For example, responsive to the crew members triggering a fasten seatbelt notification and/or responsive to the aircraft flight data indicating that the aircraft has initiated a mode associated with departure from an airport gate for takeoff, the remedial action module 204 can select one or more rules that cause the IFE server 200 to analyze video streams from the cameras 100 to determine whether seatbelt mechanism 214 of passenger occupied seats 216 remain fastened. Responsive to the IFE system 200 determining a passenger occupied seat 216 not having a fastened seatbelt apparatus, the remedial action module 204 can determine a location of the seat within the cabin and send a first corrective notification to a display device 210 or portable electronic device 218 that is associated with the seat location (e.g., constructing the passenger to take corrective action such as by fastening the seatbelt mechanism 214) and/or send another corrective notification to the crew terminal 230 that identifies the seat location where the determined condition occurs.

In this manner, the IFE server 200 can perform continuous real-time monitoring of passenger compliance with crew instructions, and can trigger remedial actions involving instructing passengers to correct compliance issues and/or notifying crewmembers when their assistance is required.

### Example IFE Server

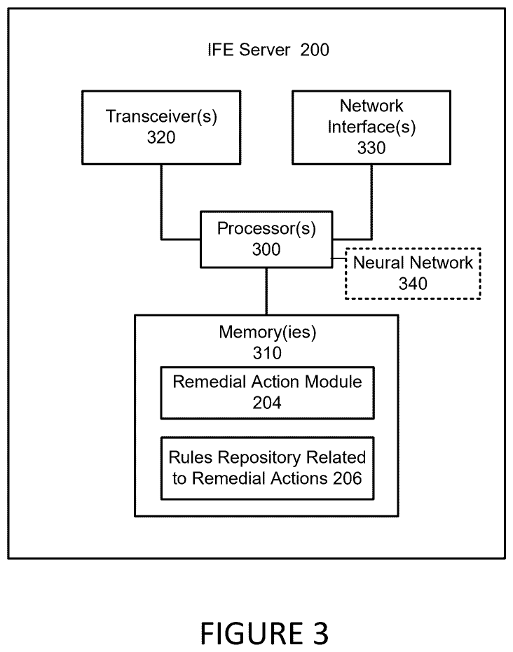

FIG. 3 illustrates an IFE server 200 having elements that are configured to operate according to some embodiments of the present disclosure. The IFE server 200 includes at least one processor circuit 300 (referred to as a processor for brevity), at least one memory circuit 310 (referred to as a memory for brevity), at least one network interface 330 (referred to as a network interface for brevity), and may further include at least one wireless transceiver 320. The network interface 330 may include at least one of multiple wired and wireless communication interfaces, such as ethernet, broadband over power lines, WiFi, 5G LTE. The IFE server 200 may further include a neural network 340, which may be at least partially implemented within the processor 300 and which can perform the neural network operations explained above for performing object recognition within the video streams, recognizing if seatbelt mechanism are fastened, providing notifications to crew terminals and/or to passenger seat video display units, and performing remedial actions.

The processor 300 may include one or more data processing circuits, such as a general purpose and/or special purpose processor (e.g., microprocessor and/or digital signal processor) that may be collocated or distributed across one or more networks. The processor 300 is configured to execute computer program code in the memory 310, described below as a non-transitory computer readable medium, to perform at least some of the operations described herein as being performed by an IFE server 200. The computer program code when executed by the processor 300 causes the processor 300 to perform operations in accordance with one or more embodiments disclosed herein for the IFE server. The computer program code can include program code for the remedial action module 204 and program code for the video object recognition module 202. The memory can also store the rules related to remedial actions 206, which is utilized by the remedial action module 204 as explained above.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. An inflight entertainment system comprising:
a content server storing content for distribution through at least one cabin network to video display units, the content server is operative to:
obtain through the at least one cabin network seatbelt status indications indicating whether seatbelt mechanisms associated with passenger seats are fastened;
determine that fastened seatbelts are required for passengers;
responsive to the determination, identify based on the seatbelt status indications which of the seats are occupied by passengers and do not have seatbelt mechanisms fastened; and
for each of the identified seats,
identify a video display unit that is associated with the identified seat,
communicate through the at least one cabin network to the video display unit a notification indicating that fastening of the seatbelt mechanism is required, and
responsive to expiration of a defined threshold time since communication of the notification without having received a seatbelt status indication associated with the identified seat indicating that the seatbelt mechanism is fastened, trigger performance of a remedial action operation through the content server.

2. The inflight entertainment system of claim 1, wherein operation to determine that fastened seatbelts are required for passengers comprises at least one of:
processing video from cameras positioned to view passenger seats to identify seatbelt fastening status;
signaling received from seatbelt fasten sensors operative to indicate whether a seatbelt mechanism is fastened; and
querying the passenger to acknowledge that the seatbelt mechanism is fastened.

3. The inflight entertainment system of claim 1, wherein operation to determine that fastened seatbelts are required for passengers comprises at least one of:
receiving a command from a crew terminal through the at least one cabin network;
obtaining an expected turbulence status indication indicating a level of expected turbulence or level of measured turbulence exceeding a threshold; and
obtaining a flight phase status indicating the aircraft is entering or within a defined flight phase.

4. The inflight entertainment system of claim 1, wherein the notification indicating that fastening of the seatbelt mechanism is required is communicated through at least one of: to a video message to be displayed on the video display unit, a text notification to be displayed on the video display unit, a photographic icon to be displayed on the video display unit, and an audio announcement to be played through an audio port of the video display unit.

5. The inflight entertainment system of claim 1, wherein the remedial action operation performed by the content server comprises sending further messaging to the passenger, including a notification to the passenger that a remedial action will occur if the seatbelt mechanism is not fastened.

6. The inflight entertainment system of claim 1, wherein the remedial action operation performed by the content server comprises turning the inflight entertainment system off.

7. The inflight entertainment system of claim 1, wherein the remedial action operation performed by the content server comprises pausing a media content being displayed on the video display unit until the seatbelt mechanisms are determined to be fastened.

8. The inflight entertainment system of claim 1, wherein the remedial action operation performed by the content server comprises throttling allowed communication bandwidth for Internet access through the at least one cabin network.

9. The inflight entertainment system of claim 1, wherein the remedial action operation performed by the content server comprises sending notification to the crew terminal indicating a location of passenger accommodations, LOPA, map as to the seatbelt status of the passenger.

10. The inflight entertainment system of claim 1, wherein the remedial action operation performed by the content server comprises recording the seatbelt status from the crew terminal as a log with the heartbeat of the screen for further examination by an airline employee.

11. The inflight entertainment system of claim 1, wherein the content server is further operative to:
responsive to a threshold amount of time elapsing, repeating until the seatbelt mechanisms associated with passenger seats are fastened:
obtain through the at least one cabin network seatbelt status indications indicating whether seatbelt mechanisms associated with passenger seats are fastened;
determine that fastened seatbelts are required for passengers;
responsive to the determination, identify based on the seatbelt status indications which of the seats are occupied by passengers and do not have seatbelt mechanisms fastened; and
for each of the identified seats,
identify a video display unit that is associated with the identified seat,
communicate through the at least one cabin network to the video display unit a notification indicating that fastening of the seatbelt mechanism is required, and
responsive to expiration of a defined threshold time since communication of the notification without having received a seatbelt status indication associated with the identified seat indicating that the seatbelt mechanism is fastened, trigger performance of a remedial action operation through the content server.

12. The inflight entertainment system of claim 1, wherein the content server is further operative to:
responsive to a determining fastened seatbelts changed from not required to required for passengers, repeating until the seatbelt mechanisms associated with passenger seats are fastened:
obtain through the at least one cabin network seatbelt status indications indicating whether seatbelt mechanisms associated with passenger seats are fastened;
identify based on the seatbelt status indications which of the seats are occupied by passengers and do not have seatbelt mechanisms fastened; and
for each of the identified seats,
identify a video display unit that is associated with the identified seat,
communicate through the at least one cabin network to the video display unit a notification indicating that fastening of the seatbelt mechanism is required, and
responsive to expiration of a defined threshold time since communication of the notification without having received a seatbelt status indication associated with the identified seat indicating that the seatbelt mechanism is fastened, trigger performance of a remedial action operation through the content server.

13. A method performed by an inflight entertainment system comprising a content server storing content for distribution through at least one cabin network to video display units, the method comprising:
obtaining through the at least one cabin network seatbelt status indications indicating whether seatbelt mechanisms associated with passenger seats are fastened;
determining that fastened seatbelts are required for passengers;
responsive to the determination, identifying based on the seatbelt status indications which of the seats are occupied by passengers and do not have seatbelt mechanisms fastened; and
for each of the identified seats,
identifying a video display unit that is associated with the identified seat,
communicating through the at least one cabin network to the video display unit a notification indicating that fastening of the seatbelt mechanism is required, and
responsive to expiration of a defined threshold time since communication of the notification without having received a seatbelt status indication associated with the identified seat indicating that the seatbelt mechanism is fastened, triggering performance of a remedial action operation through the content server.

14. The method of claim 13, wherein determining that fastened seatbelts are required for passengers comprises at least one of:
processing video from cameras positioned to view passenger seats to identify seatbelt fastening status;
signaling received from seatbelt fasten sensors operative to indicate whether a seatbelt mechanism is fastened; and
querying the passenger to acknowledge that the seatbelt mechanism is fastened.

15. The method of claim 13, wherein determining that fastened seatbelts are required for passengers comprises at least one of:
receiving a command from a crew terminal through the at least one cabin network;
obtaining an expected turbulence status indication indicating a level of expected turbulence or level of measured turbulence exceeding a threshold; and
obtaining a flight phase status indicating the aircraft is entering or within a defined flight phase.

16. The method of claim 13, wherein the notification indicating that fastening of the seatbelt mechanism is required is communicated through at least one of: to a video message to be displayed on the video display unit, a text notification to be displayed on the video display unit, a photographic icon to be displayed on the video display unit, and an audio announcement to be played through an audio port of the video display unit.

17. The method of claim 13, wherein the remedial action comprises sending further messaging to the passenger, including a notification to the passenger that a remedial action will occur if the seatbelt mechanism is not fastened.

18. The method of claim 13, wherein the remedial action comprises turning the inflight entertainment system off.

19. The method of claim 13, wherein the remedial action comprises pausing a media content being displayed on the video display unit until the seatbelt mechanisms are determined to be fastened.

20. The method of claim 13, wherein the remedial action comprises throttling allowed communication bandwidth for Internet access through the at least one cabin network until the seatbelt mechanisms are determined to be fastened.

21. The method of claim 13, wherein the remedial action comprises sending notification to the crew terminal indicating a location of passenger accommodations, LOPA, map as to the seatbelt status of the passenger.

22. The method of claim 13, wherein the remedial action comprises recording the seatbelt status from the crew terminal as a log with the heartbeat of the screen for further examination by an airline employee.

23. The method of claim 13, further comprising:
after a threshold amount of time has elapsed, repeating the steps of:
obtaining through the at least one cabin network seatbelt status indications indicating whether seatbelt mechanisms associated with passenger seats are fastened;
determining that fastened seatbelts are required for passengers;
responsive to the determination, identifying based on the seatbelt status indications which of the seats are occupied by passengers and do not have seatbelt mechanisms fastened; and
for each of the identified seats,
identifying a video display unit that is associated with the identified seat,
communicating through the at least one cabin network to the video display unit a notification indicating that fastening of the seatbelt mechanism is required, and
responsive to expiration of a defined threshold time since communication of the notification without having received a seatbelt status indication associated with the identified seat indicating that the seatbelt mechanism is fastened, triggering performance of a remedial action operation through the content server.

24. The method of claim 13, further comprising:
responsive to a determining fastened seatbelts changed from not required to required for passengers, repeating until the seatbelt mechanisms associated with passenger seats are fastened:
obtaining through the at least one cabin network seatbelt status indications indicating whether seatbelt mechanisms associated with passenger seats are fastened;
identifying based on the seatbelt status indications which of the seats are occupied by passengers and do not have seatbelt mechanisms fastened; and
for each of the identified seats,
identifying a video display unit that is associated with the identified seat,
communicating through the at least one cabin network to the video display unit a notification indicating that fastening of the seatbelt mechanism is required, and
responsive to expiration of a defined threshold time since communication of the notification without having received a seatbelt status indication associated with the identified seat indicating that the seatbelt mechanism is fastened, triggering performance of a remedial action operation through the content server.
